(19) United States
(12) Patent Application Publication
(10) Pub. No.: US 2025/0287866 A1
(43) Pub. Date: Sep. 18, 2025

(54) WORKING AIR VEHICLE, WORKING AIR VEHICLE GROUP, AND WORKING METHOD

(71) Applicant: Kubota Corporation, Osaka (JP)

(72) Inventor: Naohiro ISHIKAWA, Sakai-shi (JP)

(21) Appl. No.: 19/221,864

(22) Filed: May 29, 2025

Related U.S. Application Data
(63) Continuation of application No. PCT/JP2022/048261, filed on Dec. 27, 2022.

(51) Int. Cl. A01C 7/20

(52) U.S. Cl. CPC A01C 7/20

(57) ABSTRACT

A working aerial vehicle includes a work section configured to perform work to bring a field into a state suitable for receiving supply of a supplied material, and a supplier configured to supply the supplied material to the field on which the work is performed.

### CROSS REFERENCE TO RELATED APPLICATIONS

This application is a Continuation Application of PCT Application No. PCT/JP2022/048261 filed on Dec. 27, 2022. The entire contents of this application are hereby incorporated herein by reference.

### BACKGROUND OF THE INVENTION

### 1. Field of the Invention

The present invention relates to working aerial vehicles, working aerial vehicle groups, and working methods.

### 2. Description of the Related Art

Aerial spraying is mentioned as one of the methods that can improve the efficiency of seeding work and the like, and various techniques related to this have been proposed.

For example, PCT Japanese Translation Patent Publication No. JP2020-508925 discloses an aerial spraying method including a step of acquiring the wind speed of wind that causes drift dispersal of a sprayed material sprayed from an unmanned aerial vehicle (UAV), and a step of controlling one or a plurality of components of the UAV based on the acquired wind speed to at least reduce the drift dispersal.

Japanese Patent Application Laid-Open No. 2012-521989 discloses a composition including at least one coating including at least one seed and at least one wetting agent, as seed Suitable for aerial spraying.

Japanese Patent Application Laid-Open No. 2012-70681 discloses a vegetation bag for aerial seeding greening, which is aerially sprayed to capture flying seeds and green a greening target area, the vegetation bag including a vegetation base material and a bag body filled with the vegetation base material, in which a plan view shape of the vegetation bag is molded in an annular shape.

### SUMMARY OF THE INVENTION

In the aerial spraying technique of the related art, since the sprayed seeds are exposed on the ground surface, the seeds may be taken away by birds, animals, or the like, or may be moved by rain, wind, or the like. Thus, there were cases where the seeds could not be retained at an intended place. In addition, it was difficult to control the dispersion state of the seeds on the ground surface. On the other hand, a method of embedding seeds by ejecting the seeds toward the ground surface has also been proposed. However, in this case, the seeds may be damaged depending on the hardness of the soil, the output of the ejection, and the like.

In view of the above-described problems, it is required to bring a field into a state suitable for receiving supply of a supplied material and to supply the material to the field without damaging the material.

A working aerial vehicle according to an example embodiment of the present invention includes a work section configured to perform work to bring a field into a state suitable for receiving supply of a supplied material, and a supplier configured to supply the supplied material to the field on which the work is performed.

A working aerial vehicle group according to an example embodiment of the present invention includes a first working aerial vehicle including a work section configured to perform work to bring a field into a state suitable for receiving supply of a supplied material, and a second working aerial vehicle including a supplier configured to supply the supplied material to the field on which the work is performed.

A working method according to an example embodiment of the present invention includes a first step of performing, by a working aerial vehicle, work to bring a field into a state suitable for receiving supply of a supplied material, and a second step of supplying, by a working aerial vehicle, the supplied material to the field on which the work is performed.

According to these example embodiments, after supplying

the work material and bringing the field into a state suitable for receiving the supply of the supplied material, the supplied material is supplied to the field. Thus, the supplied material does not remain on the ground surface as it is. In addition, since the supplied material itself does not perform work on the field, the supplied material is less likely to be damaged.

Hereinafter, example embodiments of the present invention will be described. However, the scope of the present invention is not limited to the following example embodiments.

In a working aerial vehicle according to an example embodiment of the present invention, it is preferable that the work section may be configured to eject work material to the field as the work.

According to this configuration, since a hole is formed in the field, it is easy to realize a state suitable for receiving the supply of the supplied material.

In a working aerial vehicle according to an example embodiment of the present invention, it is preferable that the supplier may be configured to eject the supplied material to the field.

According to this configuration, the reliability in supplying the supplied material to the field is improved.

In a working aerial vehicle according to an example embodiment of the present invention, it is preferable that the work section may be configured to eject a work material to the field as the work, the supplier may be configured to eject the supplied material to the field, and a speed at which the work section ejects the work material may be higher than a speed at which the supplier ejects the supplied material.

According to this configuration, since a hole is formed in the field, it is easy to realize a state suitable for receiving the supply of the supplied material. In addition, it is easy to reliably form the hole.

In a working aerial vehicle according to an example embodiment of the present invention, it is preferable that the work section may be configured to eject a work material to the field as the work, the supplier may be configured to eject the supplied material to the field, and the work material may be harder than the supplied material.

According to this configuration, since a hole is formed in the field, it is easy to realize a state suitable for receiving the supply of the supplied material. In addition, it is easy to reliably form the hole.

In a working aerial vehicle according to an example embodiment of the present invention, it is preferable that the work section may be configured to eject a work material to the field as the work, the supplier may be configured to eject the supplied material to the field, and an equivalent circle diameter of the work material may be larger than an equivalent circle diameter of the supplied material.

According to this configuration, since a hole is formed in the field, it is easy to realize a state suitable for receiving the supply of the supplied material. In addition, it is easy to reliably form the hole.

In a working aerial vehicle according to an example embodiment of the present invention, it is preferable that the work section is configured to eject a work material to the field as the work, and the working aerial vehicle may further include a material outlet common to the work material and the supplied material.

According to this configuration, since the work material and the supplied material can be supplied from the same material outlet, it is easy to supply the two materials to the same place.

In a working aerial vehicle according to an example embodiment of the present invention, it is preferable that the work section may be configured to eject a work material to the field to form a hole as the work, and output of the work section is adjusted based on a depth of the hole formed by the work section.

According to this configuration, since a hole is formed in the field, it is easy to realize a state suitable for receiving the supply of the supplied material. In addition, it is easy to appropriately adjust the depth of the formed hole.

It is preferable that a working aerial vehicle according to an example embodiment of the present invention may further include a sensor configured to specify the depth of the hole and adjust the output of the work section based on a detection value of the sensor.

According to this configuration, it is easy to appropriately adjust the depth of the formed hole.

In a working aerial vehicle according to an example embodiment of the present invention, it is preferable that the output of the work section may be adjusted based on the depth of the hole which is manually input.

According to this configuration, it is easy to appropriately adjust the depth of the formed hole.

It is preferable that a working aerial vehicle according to an example embodiment of the present invention may further include a post-work section configured to perform work on the supplied material supplied to the field.

According to this configuration, since the work can be further added to the supplied material, it is easy to prepare an environment in which the purpose of supplying the supplied material is easily realized, such as preventing the supplied material from being lost due to birds, animals, wind, rain, or the like.

In a working aerial vehicle according to an example embodiment of the present invention, it is preferable that the post-work section may be configured to eject a covering material to the field, and the supplied material may be covered by the covering material.

According to this configuration, the supplied material is easily covered.

In a working aerial vehicle according to an example embodiment of the present invention, it is preferable that an equivalent circle diameter of the covering material may be larger than an equivalent circle diameter of the supplied material.

According to this configuration, the supplied material is easily covered.

It is preferable that a working aerial vehicle according to an example embodiment of the present invention may further include a material outlet common to the supplied material and the covering material.

According to this configuration, since the supply of the supplied material and the supply of the covering material can be performed from the same material outlet, it is easy to supply the two materials to the same place.

In a working method according to an example embodiment of the present invention, it is preferable that the working aerial vehicle that performs the work on the field and the working aerial vehicle that supplies the supplied material may be the same.

According to this configuration, it is easy to supply the work material and the supplied material to the same place.

In a working method according to an example embodiment of the present invention, it is preferable that the working aerial vehicle that performs the work on the field and the working aerial vehicle that supplies the supplied material may be different from each other.

According to this configuration, it is easy to simplify the configuration of each working aerial vehicle.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram of a working aerial vehicle according to an example embodiment of the present invention.

FIG. 2 is a functional configuration diagram of a working aerial vehicle according to an example embodiment of the present invention.

FIG. 3 is a schematic diagram illustrating a first supply step according to an example embodiment of the present invention.

FIG. 4 is a schematic diagram illustrating a second supply step according to an example embodiment of the present invention.

FIG. 5 is a schematic diagram illustrating a covering step according to an example embodiment of the present invention.

FIG. 6 is a schematic diagram illustrating a state in which a working method according to an example embodiment of the present invention is completed.

### DETAILED DESCRIPTION OF THE EXAMPLE EMBODIMENTS

Example embodiments of working aerial vehicles and working methods according to the present invention will be described with reference to the drawings. In the following, examples in which working aerial vehicles according to example embodiments of the present invention are applied to working aerial vehicles 1 that performs seeding will be described.

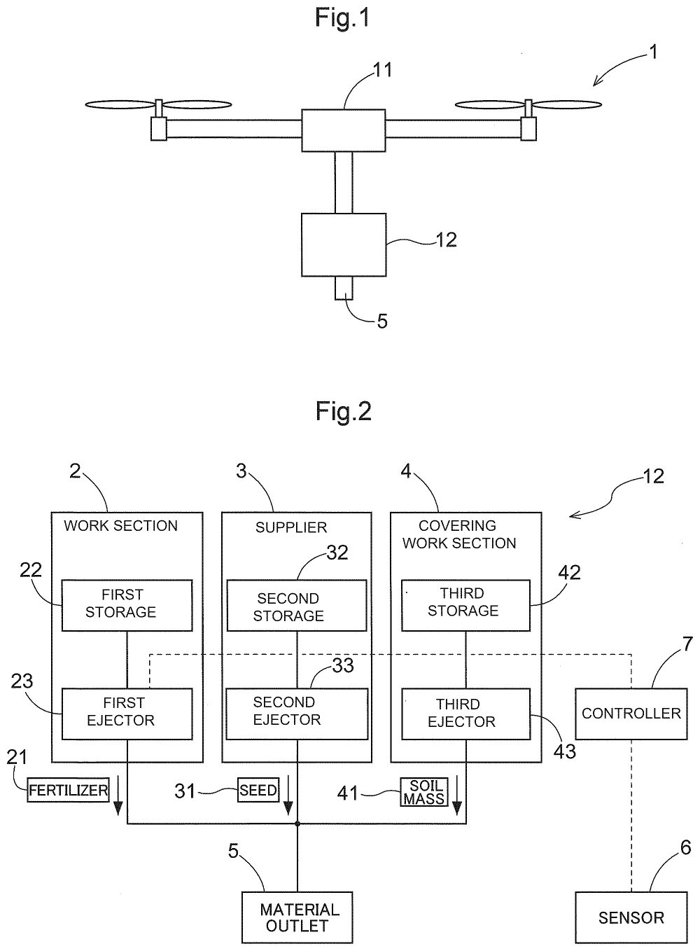

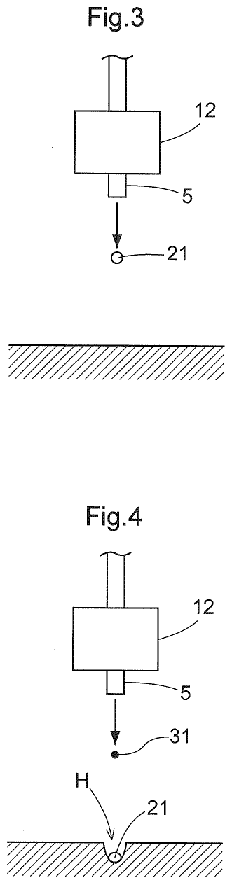

The working aerial vehicle 1 according to the present example embodiment includes an aerial vehicle 11 and a work apparatus 12, and the work apparatus 12 includes a work section 2, a supplier 3, a covering work section 4, a material outlet 5, a sensor 6, and a controller 7 (FIGS. 1 and 2). The working aerial vehicle 1 is generally a device that performs the work of forming a hole H in a field, sowing a seed 31 (an example of a supplied material) in the hole H, and covering the seed 31 (FIGS. 3 to 6).

The work section 2 ejects a fertilizer 21 (an example of a work material) to a field to form the hole H in the field, and has a first storage 22 that stores the fertilizer 21 and a first ejection device 23 that ejects the fertilizer 21. Forming the hole H in the field is an example of the work to bring the field into a state suitable for receiving the supply of the seed 31. Other examples of such work will be described below.

The fertilizer 21 may have a form that satisfies requirements such as a size, hardness, and weight that can form the hole H in a case where the fertilizer 21 is ejected to the field. In addition, the fertilizer 21 may be subjected to a treatment such as molding, curing, or encapsulation such that the hole H is easily formed. Typically, the equivalent circle diameter of the fertilizer 21 is larger than the equivalent circle diameter of the seed 31 ejected from the supplier 3. In addition, a configuration in which the fertilizer 21 is harder than the seed 31 is also a preferable configuration from the viewpoint of easily forming the hole H. However, it is acceptable that the fertilizer 21 is not harder than the seed 31 as long as the hole H can be formed. For example, in a case where the fertilizer 21 has a hardness such that the fertilizer 21 is pulverized in a case where the hole H is formed in the field, a state in which the pulverized fertilizer 21 is spread on the hole H is realized, and it is possible to expect that the pulverized fertilizer 21 acts as a cushioning material that protects the seed 31 ejected into the hole H.

The first storage 22 is a container-shaped structure that stores the fertilizer 21 and supplies the fertilizer 21 to the first ejection device 23. The configuration of the first storage 22 is appropriately selected according to the properties, shape, and the like of the fertilizer 21 to be used.

The first ejection device 23 ejects the fertilizer 21 toward the field. The first ejection device 23 needs to give sufficient kinetic energy to the fertilizer 21 through the driving thereof so that the ejected fertilizer 21 can form the hole H in the field, and the mechanism, output, and the like of the first ejection device 23 are selected to be capable of realizing this function. Examples of a specific mounting form of the first ejection device 23 include a mechanical device that ejects the fertilizer 21 by a gear rotating at a high speed, a pressurization type device that ejects the fertilizer 21 using a compressed fluid (for example, compressed air), and the like.

The supplier 3 ejects the seed 31 (an example of the supplied material) into the hole H formed by the work section 2, and has a second storage 32 that stores the seed 31 and a second ejection device 33 that ejects the seed 31.

As the seed 31, a seed of an agricultural crop may be used as it is, or a seed obtained by performing some processing on a seed collected from an agricultural crop may be used. The processing performed here includes, in addition to processing in the related art, such as the processing of adding a coating for preventing seeds from being eaten by birds or animals or the processing in which seeds are accompanied by chemicals for preventing diseases of crops or fertilizers for promoting germination, unique processing for facilitating the seeding using the working aerial vehicle 1 according to the present example embodiment, such as the processing of adding a coating for preventing the seed 31 from being damaged by an impact due to ejection and the processing of adding a coating (spherical shape, cylindrical shape, or the like) for enhancing the directionality of the ejected seed 31. In addition, the seed 31 in which a plurality of types of processing is performed simultaneously or sequentially may be used.

The second storage 32 is a container-shaped structure that stores the seed 31 and supplies the seed 31 to the first ejection device 23. The configuration of the second storage 32 is appropriately selected according to the properties, shape, and the like of the seed 31 to be used. The processing on the seed 31 may be performed in the second storage 32.

The second ejection device 33 ejects the seed 31 toward the field. Examples of a specific mounting form of the second ejection device 33 include a mechanical device, a pneumatic device, and the like, as in the first ejection device 23. However, while the first ejection device 23 needs to give sufficient kinetic energy to the fertilizer 21 so that the hole H can be formed in the field, it is preferable that the second ejection device 33 avoids an excessive ejection speed so that the ejected seed 31 is not damaged. Therefore, typically, the speed at which the first ejection device 23 (work section 2) ejects the fertilizer 21 is higher than the speed at which the second ejection device 33 (supplier 3) ejects the seed 31.

The covering work section 4 (an example of a post-work section) performs work of covering the seed 31 supplied to the hole H. In the present example embodiment, the covering work section 4 is configured to eject a soil mass 41 (which is an example of a covering material) into the hole H, and covers the seed 31 with the soil mass 41 to cover the seed 31. The covering work section 4 includes a third storage 42 that stores the soil mass 41 and a third ejection device 43 that ejects the soil mass 41.

The soil mass 41 is a mass of soil supplied to the field for the purpose of covering the seed 31 supplied to the hole H. Therefore, the shape, size, and the like of the soil mass 41 can be determined in consideration of the size of the hole H to be formed by the work section 2, the size of the seed 31, and the like. Typically, the equivalent circle diameter of the soil mass 41 is larger than the equivalent circle diameter of the fertilizer 21 and the equivalent circle diameter of the seed 31. In addition, the properties of the soil forming the soil mass 41 can be determined in consideration of the properties of the soil of the field, the properties of the soil suitable for the growth of the seed 31, and the like.

The third storage 42 is a container-shaped structure that stores the soil mass 41 and supplies the soil mass 41 to the third ejection device 43. The configuration of the third storage 42 is appropriately selected according to the shape and the like of the soil mass 41 to be used. Instead of the configuration in which the soil mass 41 is stored, a configuration in which soil before being molded into the soil mass 41 is stored in the third storage 42 and the soil mass 41 is molded in the third storage 42 may be adopted.

The third ejection device 43 ejects the soil mass 41 toward the field. Examples of a specific mounting form of the third ejection device 43 include a mechanical device, a pressurization type device, and the like, as in the first ejection device 23 and the second ejection device 33.

The material outlet 5 is an outlet common to the fertilizer 21, the seed 31, and the soil mass 41. Therefore, the material outlet 5 is connected to the first ejection device 23, the second ejection device 33, and the third ejection device 43. Since the material outlet 5 functions as an outlet in a case where the fertilizer 21, the seed 31, and the soil mass 41 is ejected to the field, the material outlet 5 is open toward the field, that is, downward.

The sensor 6 specifies the depth of the hole H formed in the field. Examples of a specific mounting form of the sensor 6 include an optical, millimeter-wave, or ultrasonic distance-measuring sensor, and an image identification device including an imaging device, and the like. The depth (detection value) of the hole H specified by the sensor 6 is output to the controller 7.

The controller 7 is configured or programmed to control the operation of a driver of the work apparatus 12. Here, the driver corresponds to the first ejection device 23, the second ejection device 33, and the third ejection device 43. The controller 7 may be configured or programmed to have a general configuration as a controller, which includes a calculator, a storage, a communication module, and the like.

The controller 7 is configured or programmed to control the output of the first ejection device 23 based on the depth of the hole H specified by the sensor 6. For example, the output of the first ejection device 23 is subjected to feedback control such that the depth of the hole H has a desired value set in advance, based on statistics of the depths of the plurality of holes H sequentially formed. The desired value of the depth of the hole H is determined based on, for example, the type of crop of the seed 31 and can be input to the controller 7 in advance.

In addition, even in a case where the field is mentioned in one word, the properties of the soil may be locally different. Therefore, even in a case where the first ejection device 23 is operated with the same output, the depth of the hole H to be formed may be different depending on locations. Therefore, data related to the hardness of the soil at each point of the field may be input to the controller 7 in advance, and the output of the first ejection device 23 may be adjusted for each point based on the data. In addition, in a case where the depth of the hole H measured by the sensor 6 is shallower than expected, the fertilizer 21 may be ejected from the first ejection device 23 again at the same spot.

Subsequently, an example embodiment of a working method for performing seeding of the seed 31 using the working aerial vehicle 1 will be described. The working method according to the present example embodiment includes a first supply step, a second supply step, and a covering step in this order.

The first supply step is a step of forming the hole H in the field by ejecting the fertilizer 21 from the working aerial vehicle 1 to the field (FIG. 3). This step is performed by the work section 2. The operation of ejecting the fertilizer 21 is an example of the operation of supplying the work material.

The second supply step is a step of ejecting the seed 31 from the working aerial vehicle 1 to the hole H (FIG. 4). That is, it can be said that the step is a step in which seeding is performed. This step is performed by the supplier 3. The operation of ejecting the seed 31 is an example of the operation of supplying the supplied material.

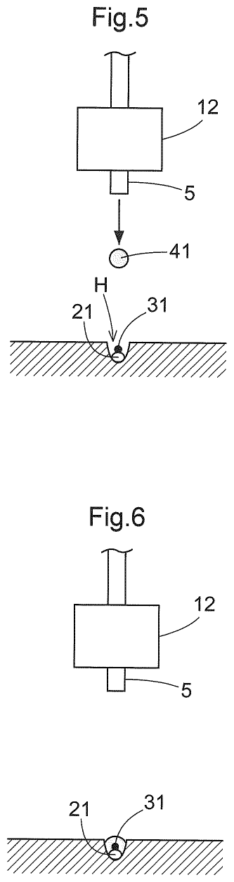

The covering step is a step of ejecting the soil mass 41 from the working aerial vehicle 1 into the hole H to cover the seed 31 (FIGS. 5 and 6). This step is performed by the covering work section 4.

The operations of the work section 2 (first ejection device 23), the supplier 3 (second ejection device 33), and the covering work section 4 (third ejection device 43) in the above-described three steps are controlled by the controller 7. In addition to the above-described feedback control of adjusting the depth of the hole H, the timing at which each of the first supply step, the second supply step, and the covering step is performed is also controlled. In this case, communication may be established with a controller (not illustrated) on the aerial vehicle 11 side, and the work apparatus 12 may be controlled in conjunction with the operation of a flying device (a propeller, a motor, or the like; not designated by a reference numeral) of the aerial vehicle 11.

### OTHER EXAMPLE EMBODIMENTS

Finally, other example embodiments of the working aerial vehicles and the working methods according to the present invention will be described. The configurations disclosed in each of the following example embodiments can also be applied in combination with the configurations disclosed in other example embodiments as long as no contradiction occurs.

In the above-described example embodiments, a configuration in which the work section 2 supplies the fertilizer 21 to the field and forms the hole H has been described as an example. However, in an example embodiment of the present invention, the feature in which the work section brings the field into a state suitable for receiving the supply of the supplied material is not limited to the work material being ejected to form the hole. The state of the field suitable for receiving the supply of the supplied material may be, for example, a state in which the field is leveled, the field is plowed, the soil is softened, the soil contains moisture, a ditch is dug, a hole is formed, harmful insects are exterminated, and a mark for a position where the supplied material is to be ejected is installed, and a work section having a configuration capable of realizing the selected state is adopted. In addition, the work section may be one that directly acts on a field, such as an implement of a tractor, in addition to one that indirectly acts on a field, such as ejecting the work material. In addition, in a case where the work section ejects the work material, the work material may be soil masses that can form holes, soil masses that can serve as a cushion for a supplied material, chemicals that has chemical efficacy for the supplied material, liquids that soften the soil of the field, containers that blend well with soil such as biodegradable containers, and the like, in addition to fertilizers. In addition, the work material may be connected to the work section and may be pulled back to the work section after acting on the field.

In the above-described example embodiments, the configuration in which the supplier 3 supplies the seed 31 to the hole H of the field has been described as an example. However, in an example embodiment of the present invention, the supplied material supplied from the supplier to the field may be fertilizers, chemicals, seedlings, pot seedlings, or the like, in addition to the seed. In addition, the method of supplying the supplied material to the field by the supplier is not limited to the method of ejecting the supplied material.

In the above-described example embodiments, the configuration in which the covering work section 4 ejects the soil mass 41 into the hole H of the field to cover the seed 31 has been described as an example. However, in an example embodiment of the present invention, the work performed by the post-work section is not limited to the covering of the supplied material. The work performed by the post-work section is typically work for creating a situation in which the purpose of supplying the supplied material is easily achieved, and may include, for example, covering the supplied material with soil to cover the supplied material, forming a groove around the supplied material to drain water, pushing the supplied material deeper into the ground, leveling the area around a point where the supplied material is supplied, and the like. Thus, the selected work can be realized in the post-work section. In addition, the post-work section may be one that directly acts on a field, such as an implement of a tractor, in addition to one that indirectly acts on a field, such as ejecting some kind of material.

In a case where the post-work section covers the supplied material, the method of covering the supplied material is not particularly limited. For example, even in a case where the covering material is ejected as in the above-described example embodiments, the covering material may be water, fertilizers, chemicals (particularly, those having significant effects when supplied above the supplied material), materials that blend well with soil, such as biodegradable materials, or materials (such as rubber-like materials or jelly-like materials) that can permeate or dissolve in soil, and are not limited to soil masses. In addition, a method of moving soil around the supplied material to cover the supplied material may be adopted instead of or in addition to the ejection of the covering material. In any case, the post-work section having a configuration suitable for the selected method can be mounted.

In the above-described example embodiments, a configuration in which the work section 2, the supplier 3, and the covering work section 4 share the material outlet 5 has been described as an example. However, in an example embodiment of the present invention, in a case where some or all of the work section, the supplier, and the optionally provided post-work section eject any material, each of the work section, the supplier, and the post-work section may have an independent material outlet.

In the above-described example embodiments, a configuration in which the depth of the hole H is controlled by controlling the output of the first ejection device 23 based on the depth of the hole H specified by the sensor 6 has been described as an example. However, in a case where a hole is formed in an example embodiment of the present invention, a desired depth of the hole may be manually input, and the output of the work section may be controlled based on the input depth.

In the above-described example embodiments, a configuration in which the working aerial vehicle 1 includes the aerial vehicle 11 and the work apparatus 12, and the work apparatus 12 has individual functional units such as the work section 2, the supplier 3, and the covering work section 4 has been described as an example. However, a working aerial vehicle according to an example embodiment of the present invention may be an airframe in which an aerial vehicle portion having a flying function, the work section, the supplier, and the optionally provided post-work section are integrally provided.

In the above-described example embodiments, a configuration in which one working aerial vehicle 1 includes the aerial vehicle 11 and the work apparatus 12, and the work apparatus 12 includes individual functional units such as the work section 2, the supplier 3, and the covering work section 4 has been described as an example. However, the work section and the supplier in an example embodiment of the present invention may be provided to be distributed in a plurality of working aerial vehicles. That is, a working aerial vehicle group including a first working aerial vehicle including a work section configured to perform work to bring a field into a state suitable for receiving supply of a supplied material, and a second working aerial vehicle including a supplier configured to supply the supplied material to the field on which the work is performed is also an example embodiment of the present invention. In addition, in a case where the post-work section is further provided in this example embodiment of the present invention, the post-work section may be provided in the second working aerial vehicle, may be provided in a working aerial vehicle different from the first working aerial vehicle and the second working aerial vehicle, or may be provided in a working aerial vehicle that travels on the ground, such as a tractor.

In the above-described example embodiments, although the working aerial vehicle 1 has been described as an example, a configuration may be adopted in which a work machine including a work section configured to perform work to bring a field into a state suitable for receiving supply of a supplied material and a supplier configured to supply the supplied material to the field on which the work has been performed may be configured to travel on the ground. In this case as well, a configuration in which the field is brought into a state suitable for receiving the supply of the supplied material by ejecting the material, as exemplified in the above-described example embodiments, can be appropriately adopted.

Regarding other configurations, it should be understood that the example embodiments disclosed in the present specification are merely examples in all points and that the scope of the present invention is not limited thereto. Those skilled in the art can easily understand that appropriate modifications can be made without departing from the spirit of the present invention.

Therefore, other example embodiments modified without departing from the spirit of the present invention are also naturally included in the scope of the present invention.

Example embodiments of the present invention can be used for various kinds of work (for example, seeding work or the like) performed in a field by human labor or by using a work machine.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working aerial vehicle, comprising:
a work section configured to perform work to bring a field into a state suitable for receiving supply of a supplied material; and
a supplier configured to supply the supplied material to the field on which the work is performed.

2. The working aerial vehicle according to claim 1, wherein the work section is configured to eject a work material to the field as the work.

3. The working aerial vehicle according to claim 1, wherein the supplier is configured to eject the supplied material to the field.

4. The working aerial vehicle according to claim 1, wherein
the work section is configured to eject a work material to the field as the work;
the supplier is configured to eject the supplied material to the field; and
a speed at which the work section ejects the work material is higher than a speed at which the supplier ejects the supplied material.

5. The working aerial vehicle according to claim 1, wherein
the work section is configured to eject a work material to the field as the work;
the supplier is configured to eject the supplied material to the field; and
the work material is harder than the supplied material.

6. The working aerial vehicle according to claim 1, wherein
the work section is configured to eject a work material to the field as the work;
the supplier is configured to eject the supplied material to the field; and
an equivalent circle diameter of the work material is larger than an equivalent circle diameter of the supplied material.

7. The working aerial vehicle according to claim 1, wherein
the work section is configured to eject a work material to the field as the work;
the working aerial vehicle further comprises a material outlet common to the work material and the supplied material.

8. The working aerial vehicle according to claim 1, wherein
the work section is configured to eject a work material to the field to form a hole as the work; and
an output of the work section is adjusted based on a depth of the hole formed by the work section.

9. The working aerial vehicle according to claim 8, further comprising:
a sensor configured to specify the depth of the hole; wherein
the output of the work section is adjusted based on a detection value of the sensor.

10. The working aerial vehicle according to claim 8, wherein the output of the work section is adjusted based on the depth of the hole which is manually input.

11. The working aerial vehicle according to claim 1, further comprising:
a post-work section configured to perform work on the supplied material supplied to the field.

12. The working aerial vehicle according to claim 11, wherein
the post-work section is configured to eject a covering material to the field; and
the supplied material is covered by the covering material.

13. The working aerial vehicle according to claim 12, wherein an equivalent circle diameter of the covering material is larger than an equivalent circle diameter of the supplied material.

14. The working aerial vehicle according to claim 12, further comprising a material outlet common to the supplied material and the covering material.

15. A working aerial vehicle group, comprising:
a first working aerial vehicle including a work section configured to perform work to bring a field into a state suitable for receiving supply of a supplied material; and
a second working aerial vehicle including a supplier configured to supply the supplied material to the field on which the work is performed.

16. A working method, comprising:
performing, by a working aerial vehicle, work to bring a field into a state suitable for receiving supply of a supplied material; and
supplying, by a working aerial vehicle, the supplied material to the field on which the work is performed.

17. The working method according to claim 16, wherein the working aerial vehicle that performs the work on the field and the working aerial vehicle that supplies the supplied material are the same.

18. The working method according to claim 16, wherein the working aerial vehicle that performs the work on the field and the working aerial vehicle that supplies the supplied material are different from each other.
